(19) United States
(12) Patent Application Publication
(10) Pub. No.: US 2022/0053284 A1
(43) Pub. Date: Feb. 17, 2022

(54) COMMUNICATIONS BETWEEN HOSTS AND HUMAN INTERFACE DEVICES

(71) Applicant: Hewlett-Packard Development Company, L.P., Spring, TX (US)

(72) Inventors: Adolfo Adolfo Gomez, Fort Collins, CO (US); Peter A. Seiler, Fort Collins, CO (US); Aaron M. Laaveg, Fort Collins, CO (US)

(73) Assignee: Hewlett-Packard Development Company, L.P., Spring, TX (US)

(21) Appl. No.: 17/274,459

(22) PCT Filed: Dec. 4, 2018
(86) PCT No.: PCT/US2018/063886

§ 371 Date: Mar. 9, 2021

(51) Int. Cl. H04W 4/02; G06F 3/038

(52) U.S. Cl. CPC H04W 4/023; G06F 3/038

(57) ABSTRACT

In an example implementation according to aspects of the present disclosure, a method may include retrieving, at a human interface device (HID), proximity information of hosts from a plurality of hosts configured to communicate with the HID, determining a host from the plurality of hosts that is most proximate to the HID, and allowing the host to initiate communications with the HID.

### BACKGROUND

Human interface devices (HIDs) such as a keyboard, mouse, audio input/output device, display, or virtual reality head-mounted display, may be associated with hosts, such as a computing device, to be used by a user of the computing device, for example, to take input from the user and/or give output to them. As an example, a need may arise to employ a plurality of HIDs across a plurality of computing devices. These use cases may require external switching devices to manage the connections of the HIDs to the computing devices, thereby possibly requiring extra components and deployment complexity. As an example, when using a single keyboard and mouse between multiple computing devices, a switch may be employed and is used to manually control the connection of the HIDs to the targeted computing device. However, in the absence of a switch, if the HIDs are connected directly to a computing device, if a need arises to use the HIDs with another computing device, they may be manually disconnected from the initial computing device and reconnected to the other computing device.

### BRIEF DESCRIPTION OF THE DRAWINGS

FIG. 1 illustrates a HID for switching between hosts from a plurality of hosts, based on proximity detection, according to an example;

FIGS. 2A-B illustrate the HID switching between hosts, as the relative position of the HID changes, according to an example;

FIGS. 3A-B illustrate the HID switching between hosts, upon exceeding a threshold distance, according to an example; and

FIG. 4 is a flow diagram in accordance with an example of the present disclosure.

### DETAILED DESCRIPTION

Examples disclosed herein provide the ability for an HID to dynamically, automatically, and transparently switch association between hosts from a plurality of hosts, based on proximity detection. As an example, the HID may be transitioned from one host to another, in terms of wireless connectivity, based on time of flight calculations or signal strength, or some other method of calculating distances between the HID and hosts from the plurality of hosts. With regards to wireless connectivity mediums, various technologies may be utilized, such as WiFi, WiGig, Near Field Communications (NFC), or a personal area network transfer protocol like Bluetooth. By enabling an HID to switch between multiple hosts, based on proximity detection, total cost of deployment may be reduced, workflows may be simplified, and clutter may be eliminated, for example, by eliminating the need for external switching devices.

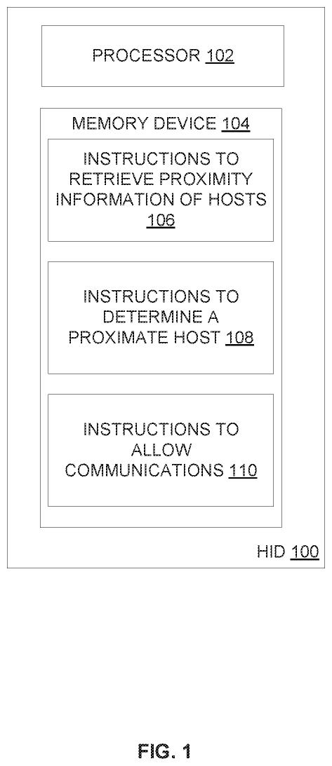

With reference to the figures, FIG. 1 illustrates a HID 100 for switching between hosts from a plurality of hosts configured to communicate with the HID 100, such as computing devices, based on proximity detection, according to an example. As mentioned above, the HID 100 may transition from one host to another, based on a wireless medium, such as Bluetooth. As an example, the plurality of hosts may be configured to communicate with the HID 100 by being previously paired to the HID 100. As a result, when the HID 100 switches from one host to another host, the HID 100 may allow for the closer host to connect with the HID 100, as will be further described.

The HID 100 depicts a processor 102 and a memory device 104 and, as an example of the HID 100 performing its operations, the memory device 104 may include instructions 106-110 that are executable by the processor 102. Thus, memory device 104 can be said to store program instructions that, when executed by processor 102, implement the components of the HID 100. The executable program instructions stored in the memory device 104 include, as an example, instructions to retrieve proximity information of hosts (106), instructions to determine a proximate host (108), and instructions to allow communications (110).

Instructions to retrieve proximity information of hosts (106) represent program instructions that when executed by the processor 102 cause the HID 100 to retrieve proximity information of hosts from the plurality of hosts that are within communication distance of the HID 100. As an example, although the HID 100 may have been previously paired with each host from the plurality of hosts, the HID 100 may retrieve proximity information from only those hosts that are currently within communication distance of the HID 100 (e.g., within Bluetooth range). As an example, the proximity information of the hosts to the HID 100 are determined by received signal strength, time of flight calculations, or other wireless ranging methods, alone or in combination. As an example, received signal strength may correspond to the transmitter power output, for example, from a host, as received by a reference antenna, for example, at the HID 100, at a distance from the transmitting antenna (i.e., a measurement of the power present in a received radio signal). Similarly, time of flight calculations may correspond to the time that an object, such as an electromagnetic wave, needs to travel a distance through a medium, for example, between each host and the HID 100. Such proximity information may be determined, for example, from either each host that is within communication distance of the HID 100, or by the HID 100 itself. However, in the interest of conserving battery at the HID 100, such proximity information may be determined by each host with respect to the HID 100, then retrieved by the HID 100.

Instructions to determine a proximate host (108) represent program instructions that when executed by the processor 102 cause the HID 100 to determine a host from the plurality of hosts that is most proximate to the HID, based on the proximity information retrieved. As will be further described, it may be more desirable for the HID 100 to switch communications to the most proximate host, as the user will likely intend to use the HID 100 with the host (e.g., computing device) that is closest to the HID 100. As an example, the most proximate host may correspond to a subset of hosts, rather than a single host. In addition, rather than determining a single host that is most proximate, the HID 100 may determine which hosts are within a threshold range of the HID 100.

As an example, the most proximate host is determined by comparing the proximity information of each host from the plurality of hosts that are within communication distance of the HID 100. As an example, if the proximity information is determined by received signal strength, the host having the highest measurement of power in signals exchanged between the host and the HID 100 may be the most proximate host. Similarly, if the proximity information is determined by time of flight calculations, the host having the lowest time of flight calculations for exchanging signals with the HID 100 may be the most proximate host. Although the wireless ranging methods are described separately, they may be used in combination to determine the proximity of each host with respect to the HID 100.

Instructions to allow communications (110) represent program instructions that when executed by the processor 102 cause the HID 100 to allow the most proximate host to initiate communications with the HID 100. As mentioned above, upon determining the most proximate host, the HID 100 may allow for the most proximate host to connect with the HID 100. As an example, if the most proximate host was previously paired to the HID 100, the HID 100 may allow for the host to re-pair with the HID 100, in order to initiate communications.

As an example, while connected to a host, the HID 100 may continue to retrieve proximity information of hosts from the plurality of hosts within communication distance of the HID 100, and determine which host is most proximate. This is particularly useful as placement of the HID 100 and hosts may change over time, for example, as a user with the HID 100 may move between the plurality of hosts. As an example, if the HID 100 is exchanging communications with a first host from the plurality of hosts, if the HID 100 later determines that a second host from the plurality of hosts is more proximate to the HID 100 than the first host, the HID 100 may terminate the connection between the HID 100 and the first host, then allow the second host to initiate communications with the HID 100. However, in order to avoid the HID 100 from switching constantly between the first and second hosts, which may not be intended by the user, especially when the first and second hosts are in close proximity to each other, or equidistant from the HID 100, the HID 100 may determine to allow the second host to initiate communications with the HID 100 only upon determining that the distance between the HID 100 and the first host is exceeded by a threshold distance, as will be further described.

Memory device 104 represents generally any number of memory components capable of storing instructions that can be executed by processor 102. Memory device 104 is non-transitory in the sense that it does not encompass a transitory signal but instead is made up of at least one memory component configured to store the relevant instructions. As a result, the memory device 104 may be a non-transitory computer-readable storage medium. Memory device 104 may be implemented in a single device or distributed across devices. Likewise, processor 102 represents any number of processors capable of executing instructions stored by memory device 104. Processor 102 may be integrated in a single device or distributed across devices. Further, memory device 104 may be fully or partially integrated in the same device as processor 102, or it may be separate but accessible to that device and processor 102.

In one example, the program instructions 106-110 can be part of an installation package that when installed can be executed by processor 102 to implement the components of the HID 100. In this case, memory device 104 may be a portable medium such as a CD, DVD, or flash drive or a memory maintained by a server from which the installation package can be downloaded and installed. In another example, the program instructions may be part of an application or applications already installed. Here, memory device 104 can include integrated memory such as a hard drive, solid state drive, or the like.

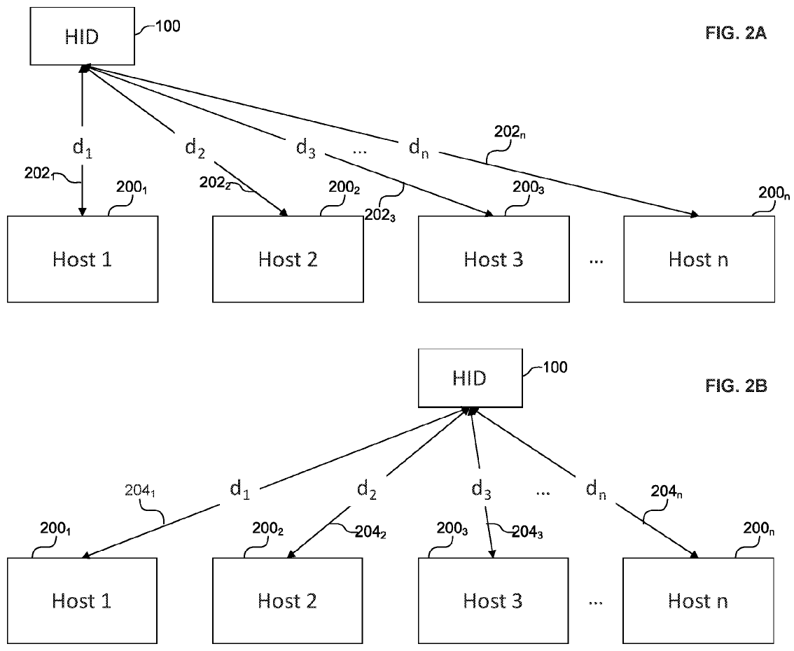

FIGS. 2A-B illustrate the HID 100 switching between hosts 200₁-200ₙ, as the relative position of the HID 100 changes, according to an example. Referring to FIG. 2A, the HID 100 retrieves proximity information of hosts 200₁-200ₙ that are within communication distance of the HID 100. As described above, the proximity information of the hosts 200₁-200ₙ to the HID 100 may be determined by received signal strength, time of flight calculations, or other wireless ranging methods, alone or in combination. As illustrated in FIG. 2A, the proximity information of host 200₁ to HID 100 may correspond to a distance d₁ 202₁. Similarly, the proximity information of host 200ₙ to HID 100 may correspond to a distance dₙ 202ₙ. Upon comparing the distances of each host with respect to the HID 100, the HID 100 may determine that host 1 200₁ is the most proximate host to the HID 100. As a result, HID 100 may allow host 1 200₁ to initiate communications with the HID 100.

Referring to FIG. 2B, upon establishing a connection between HID 100 and host 1 200₁, the HID 100 may continue to retrieve proximity information of the hosts 200₁-200ₙ, for example, as the relative position of the HID 100 with respect to the hosts 200₁-200ₙ changes. As a result, the wireless ranging methods used, such as received signal strength and time of flight calculations, may provide different proximity information of the hosts 200₁-200ₙ to the HID 100. As illustrated in FIG. 2B, the proximity information of host 200₁ to HID 100 may correspond to a changed distance d₁ 204₁. Similarly, the proximity information of host 200ₙ to HID 100 may correspond to a changed distance dₙ 204ₙ. Upon comparing the changed distances of each host with respect to the HID 100, the HID 100 may determine that host 3 200₃ is now the most proximate host to the HID 100. As a result, HID 100 may terminate connection between the HID 100 and host 1 200₁, and allow for host 3 200₃ to initiate communications with the HID 100.

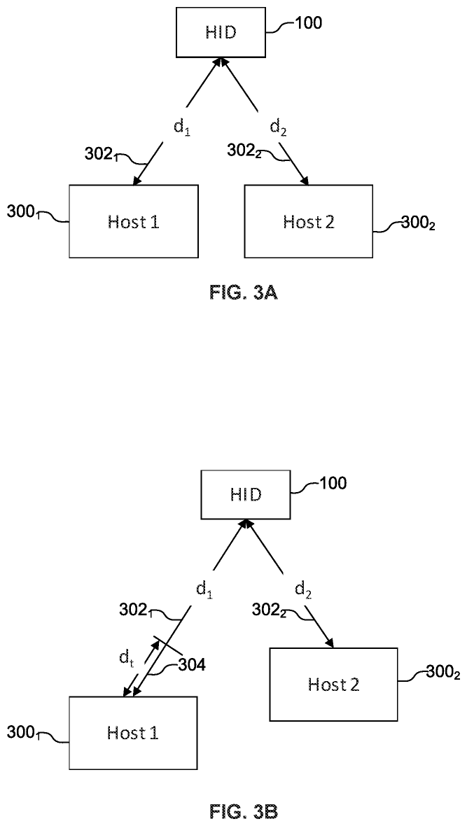

As an example, the HID 100 may switch from host 1 200₁ to host 3 200₃, only after moving a threshold distance from host 1 200₁. As a result, communications between HID 100 and host 1 200₁ may remain while the HID 100 is a certain distance around host 1 200₁, even if another host is determined to be more proximate after the communication is established between the HID 100 and host 1 200₁, as will be further described (e.g., see FIGS. 3A-B). Furthermore, an element of time may be used to determine if the HID 100 is more proximate to one host versus another for a predetermined period of time, as will be further described. As such, in FIG. 2B, the HID 100 may skip pairing attempts with host 2 200₂ as it may only briefly be the closest proximity before being in the closest proximity with host 3 200₃ for a period of time determined to be longer than a predetermined amount of time to warrant the HID 100 to allow pairing with host 3 200₃.

FIGS. 3A-B illustrate the HID 100 switching between host 300₁ and host 300₂, upon exceeding a threshold distance d₁ 304, according to an example. Referring to FIG. 3A, the HID 100 retrieves proximity information of host 300₁ and host 300₂ that are within communication distance of the HID 100. As described above, the proximity information of the host 300₁ and host 300₂ to the HID 100 may be determined by received signal strength, time of flight calculations, or other wireless ranging methods, alone or in combination. As illustrated in FIG. 3A, the proximity information of host 300₁ to HID 100 may correspond to a distance d₁ 302₁. Similarly, the proximity information of host 300₂ to HID 100 may correspond to a distance d₂ 302₂. As illustrated, the distances d₁ 302₁ and d₂ 302₂ may be similar or equal in value (e.g., equidistant from the HID 100). In such situations, the HID 100 may have the logic to choose the appropriate host. As an example, the hosts may be prioritized, or a default host may be chosen when the distances between the HID 100 and hosts are similar or equal. As an example, if host 1 300₁ is chosen, HID 100 may allow host 1 300₁ to initiate communications with the HID 100.

Referring to FIG. 3B, upon establishing a connection between HID 100 and host 1 300₁, the HID 100 may continue to retrieve proximity information of the hosts 300₁-300₂, for example, as the relative position of the HID 100 with respect to the hosts 300₁-300₂ changes. As a result, the wireless ranging methods used, such as received signal strength and time of flight calculations, may provide different proximity information of the hosts 300₁-300₂ to the HID 100. However, in order to avoid the HID 100 from switching constantly between the host 300₁ and host 300₂, which may not be intended by the user, especially when the hosts are in close proximity to each other, or equidistant from the HID 100, as illustrated in FIG. 3A, the HID 100 may determine to allow the other host (e.g., host 300₂) to initiate communications with the HID 100 only upon determining that the distance between the HID 100 and the first host (e.g., host 300₁) is exceeded by a threshold distance d₁ 304. As a result, if the relative position of the HID 100 from host 1 300₁ has not exceeded threshold distance d₁304, the HID 100 may remain connected to host 1 300₁, even if host 2 300₂ is determined to be more proximate. However, once the distance between the HID 100 and host 300₁ is exceeded by the threshold distance d₁304, as illustrated in FIG. 3B, HID 100 may terminate connection between the HID 100 and host 1 300₁, and allow for host 2 300₂ to initiate communications with the HID 100.

Furthermore, an element of time may be employed such that the termination of a connection between HID 100 and host 1 300₁ may require that the HID 100 exceed the threshold distance d₁304 for a predetermined period of time. As a result, even if the HID 100 is only briefly more proximate to host 2 300₂ than host 1 300₁, then the HID 100 once again becomes more proximate with host 1 300₁, before a predetermined period of time has elapsed, the HID 100 may maintain connection to host 1 300₁.

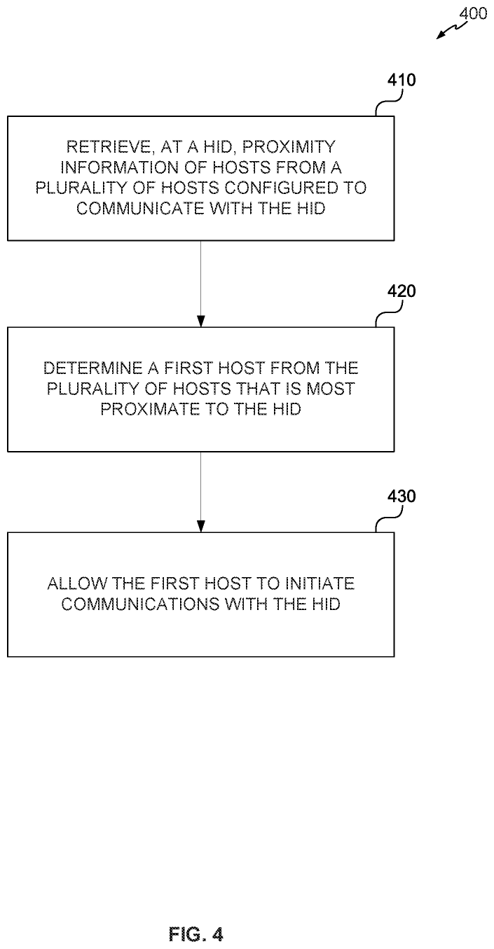

FIG. 4 is a flow diagram 400 of steps taken by a HID to switch between hosts, according to an example. Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

At 410, the HID retrieves proximity information of hosts from a plurality of hosts configured to communicate with the HID. As an example, the hosts from the plurality of hosts are within communication distance of the HID. As described above, the proximity information of the hosts may be determined by received signal strength, time of flight calculations, or other wireless ranging methods.

At 420, the HID determines a first host from the plurality of hosts that is most proximate to the HID. As an example, if the proximity information is determined by received signal strength, the host having the highest measurement of power in signals exchanged between the host and the HID may be the most proximate host. Similarly, if the proximity information is determined by time of flight calculations, the host having the lowest time of flight calculations for exchanging signals with the HID may be the most proximate host. Although the wireless ranging methods are described separately, they may be used in combination to determine the proximity of each host with respect to the HID.

At 430, the HID allows the first host to initiate communications with the HID. As an example, if the most proximate host was previously paired to the HID, the HID may allow for the host to re-pair with the HID, in order to initiate communications.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a human interface device (HID);
a plurality of hosts configured to communicate with the HID; and
a processor to:
retrieve proximity information of hosts from the plurality of hosts within communication distance of the HID;
based on the proximity information, determine a first host from the plurality of hosts that is most proximate to the HID; and
allow the first host to initiate communications with the HID.

2. The system of claim 1, wherein, as the HID is connected to the first host, the processor is to:
determine that a position of the HID with respect to the plurality of hosts changes;
upon the change in position, determine that a second host from the plurality of hosts is more proximate to the HID than the first host;
terminate the connection between the HID and the first host; and
allow the second host to initiate communications with the HID.

3. The system of claim 2, wherein the processor to determine that the second host is more proximate to the HID than the first host comprises the processor to determine that a distance between the HID and the first host is exceeded by a threshold distance.

4. The system of claim 2, wherein the processor to determine that the second host is more proximate to the HID than the first host comprises the processor to determine that the second host is more proximate to the HID for at least a predetermined period of time.

5. The system of claim 1, wherein the proximity information of the hosts are determined by received signal strength, time of flight calculations, or other wireless ranging methods.

6. The system of claim 1, wherein the processor to determine the first host is most proximate comprises the processor to compare the proximity information of each host from the plurality of hosts.

7. The system of claim 1, wherein the plurality of hosts configured to communicate with the HID comprise hosts previously paired to the HID.

8. The system of claim 7, wherein the processor to allow the first host to initiate communications with the HID comprises the processor to allow the first host to connect with the HID.

9. A non-transitory computer-readable storage medium comprising program instructions which, when executed by a processor of a computing device, cause the processor to:
retrieve proximity information of hosts from a plurality of hosts configured to communicate with a human interface device (HID), wherein the hosts from the plurality of hosts are within communication distance of the HID;
compare the proximity information of each host from the plurality of hosts;
upon comparing, determine a first host from the plurality of hosts that is most proximate to the HID; and
allow the first host to initiate communications with the HID.

10. The non-transitory computer-readable storage medium of claim 9, wherein, as the HID is connected to the first host, comprising program instructions which, when executed by the processor, cause the processor to:
determine that a position of the HID with respect to the plurality of hosts changes;
upon the change in position, determine that a second host from the plurality of hosts is more proximate to the HID than the first host;
terminate the connection between the HID and the first host; and
allow the second host to initiate communications with the HID.

11. The non-transitory computer-readable storage medium of claim 10, wherein the program instructions to determine that the second host is more proximate to the HID than the first host comprises program instructions to determine that a distance between the HID and the first host is exceeded by a threshold distance.

12. The non-transitory computer-readable storage medium of claim 9, wherein the proximity information of the hosts are determined by received signal strength, time of flight calculations, or other wireless ranging methods.

13. The non-transitory computer-readable storage medium of claim 9, wherein the plurality of hosts configured to communicate with the HID comprise hosts previously paired to the HID.

14. A method comprising:
retrieving, at a human interface device (HID), proximity information of hosts from a plurality of hosts configured to communicate with the HID, wherein the hosts from the plurality of hosts are within communication distance of the HID, and wherein the proximity information of the hosts are determined by received signal strength, time of flight calculations, or other wireless ranging methods;
determining a first host from the plurality of hosts that is most proximate to the HID; and
allowing the first host to initiate communications with the HID.

15. The method of claim 14,
determining that a position of the HID with respect to the plurality of hosts changes;
upon the change in position, determining that a second host from the plurality of hosts is more proximate to the HID than the first host;
terminating the connection between the HID and the first host; and
allowing the second host to initiate communications with the HID.
